(19) United States
(12) Patent Application Publication
(10) Pub. No.: US 2006/0271585 A1
(43) Pub. Date: Nov. 30, 2006

(54) Electronic apparatus which performs searching and control method thereof

(75) Inventor: Joon-hwan Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/267,410

(22) Filed: Nov. 7, 2005

(30) Foreign Application Priority Data
May 27, 2005 (KR) 2005-0045175

(51) Int. Cl. G06F 7/00

(52) U.S. Cl. 707/102

(57) ABSTRACT

An electronic apparatus, having a plurality of search information, includes a display part; a user selection part to select a consecutive search function; and a controller to control the display part to increase and decrease search speed with respect to the search information, and allow the searched search information to be displayed on the display part when the consecutive search function is selected through the user selection part. Thus, the electronic apparatus which performs searching and control method thereof provide an electronic apparatus which searches search information quickly and easily by using a consecutive search function.

### CROSS-REFERENCE TO RELATED APPLICATIONS

This application claims priority from Korean Patent Application No. 2005-0045175, filed on May 27, 2005, in the Korean Intellectual Property Office, the disclosure of which is incorporated herein by reference.

### BACKGROUND OF THE INVENTION

1. Field of the Invention

The present invention relates to an electronic apparatus and a control method thereof, and more particularly, to an electronic apparatus having a consecutive search function and a control method thereof.

2. Description of the Related Art

Generally, an electronic apparatus refers to consumer electronics products such as TVs, electric kitchen appliances, mobile phones, AV products, etc.

As the electronic apparatus comprises much search information, it is required to search information quickly and easily.

For example, if the electronic apparatus is provided as a TV, the search information may be broadcast channels. If the broadcast channel which is currently being displayed is channel No. 2 and a user wants to view the channel No. 55, then a user should press an up/down button 53^{rd} times to view the desired channel, or selects a consecutive search function that searches information consecutively until a user stops it.

If searching names from a mobile phone in an alphabetical order, a user may find names by selecting the consecutive search function through a user selection part. However, if searching for “Samsung Electronics” from the mobile phone, it is required to stop the consecutive search function in a name order close to the “Samsung Electronics” and find it.

### SUMMARY OF THE INVENTION

Accordingly, it is an aspect of the present invention to provide an electronic apparatus which searches search information quickly and easily by using a consecutive search function.

Additional aspects of the present invention will be set forth in part in the description which follows and, in part, will be obvious from the description, or may be learned by practice of the present invention.

The foregoing and other aspects of the present invention are also achieved by providing an electronic apparatus having a plurality of search information, comprising a display part; a user selection part to select a consecutive search function; and a controller to control the display part to increase and decrease search speed of the search information, and allow the searched search information to be displayed on the display part when the consecutive search function is selected through the user selection part.

According to an aspect of the present invention, the display part displays a list of the search information, and displays the selected search information to be distinguished from other search information.

According to another aspect of the present invention, the electronic apparatus further comprises an interface generator to generate an interface picture which is displayed on the display part, and the interface picture comprises a speed adjusting menu to adjust at least one of the fastest search speed, the slowest search speed and search speed increase/decrease rate.

According to another aspect of the present invention, the search speed is increased and decreased periodically.

According to another aspect of the present invention, the electronic apparatus further comprises an interface generator to generate the interface picture which is displayed on the display part, and the interface picture comprises a period adjusting menu to adjust increase/decrease periods of the search speed.

According to another aspect of the present invention, the display part displays the searched search information only.

According to another aspect of the present invention, the electronic apparatus further comprises a tuner to select a broadcast channel, and the searched search information comprises an image corresponding to the broadcast channel and the controller controls the tuner to display the image corresponding to the searched broadcast channel on the display part if the consecutive search function is selected.

According to another aspect of the present invention, the electronic apparatus further comprises an interface generator to generate the interface picture which is displayed on the display part, and the interface picture comprises a period adjusting menu to adjust increase/decrease periods of the search speed.

According to another aspect of the present invention, the search speed is increased and decreased on the basis of a preset reference speed which is recognizable.

The foregoing and/or other aspects of the present invention are achieved by providing a control method of an electronic apparatus having a plurality of search information, comprising receiving a selection signal of a consecutive search function; increasing and decreasing a search speed with respect to the search information if the selection signal of the consecutive search function is received; and displaying the selected search information.

According to another aspect of the present invention, the displaying of the selected search information comprises displaying a list of the search information, and displaying the searched search information to be distinguished from other search information.

According to another aspect of the present invention, the control method further comprises displaying a speed adjusting menu to adjust at least one of the fastest search speed, the slowest search speed and search speed increase/decrease rate of the search speed.

According to another aspect of the present invention, the search speed is increased and decreased periodically.

According to an aspect of the present invention, the control method further comprises displaying a period adjusting menu to adjust a search period of the search speed.

According to another aspect of the present invention, the displaying the searched search information comprises displaying the searched search information only.

According to another aspect of the present invention, the searched search information comprises an image corresponding to a TV channel.

According to another aspect of the present invention, the control method further comprises displaying a period adjusting menu to adjust a search period of the search speed.

### BRIEF DESCRIPTION OF THE DRAWINGS

The above and/or other aspects of the present invention will become apparent and more readily appreciated from the following description of exemplary embodiments, taken in conjunction with the accompanying drawings of which:

FIG. 1 is a control block diagram of an electronic apparatus according to an embodiment of the present invention;

FIG. 2 illustrates a search speed of the electronic apparatus according to another embodiment of the present invention;

FIG. 3 illustrates menus to adjust a consecutive search function which is displayed on a display part of the electronic apparatus according to another embodiment of the present invention; and

FIG. 4 is a control flow chart of the electronic apparatus according to another embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to like elements throughout.

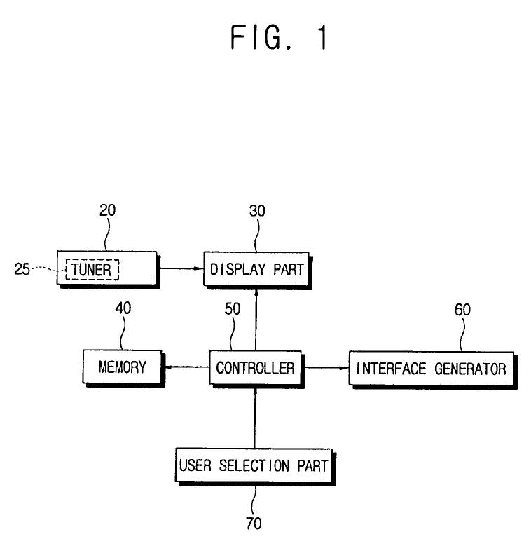

As shown in FIG. 1, an electronic apparatus according an exemplary embodiment of the present invention comprises a display part 30 to display a picture thereon, a user selection part 70 and a controller 50 to control the foregoing elements. The electronic apparatus according another embodiment of he present invention may further comprise a signal processor 20; an interface generator 60 to generate an interface picture which is displayed on the display part 30; and a memory 40 to store predetermined information.

The display part 30 according to the present invention receives a signal which is processed by the signal processor 20 to display the picture thereon. The display part 30 comprises a display module (not shown) to display the picture, and a module driver (not shown) to process the signal input from the signal processor 20 and display the picture on the display module. Here, a cathode ray tube (CRT), a digital light processing (DLP), a liquid crystal display (LCD), or a plasma display panel (PDP) may be provided as the display module according to the present invention.

If the DLP is provided as the display module, the module driver may comprise an optical engine. If the LCD is provided as the display module, the module driver may comprise a printed circuit board (PCB) which converts the signal input from the signal processor 20 into a data signal and a gate signal. Also, the display part 30 may comprise a module driver corresponding to the type of the display module.

The signal processor 20 may comprise various configurations. For example, the signal processor 20 may comprise at least one of a scaler to scale a picture signal and convert it into a vertical frequency, resolution, picture ratio, etc. which conform to output standards of the display part 30; a transition minimized differential signaling (TMDS) receiver to convert the input picture signal into digital R, G and B signals to be processed by the scaler, corresponding to the format of the input picture signal; an A/D converter; a video decoder; and a tuner 25.

The memory 40 is stored with a plurality of search information. Here, the search information comprises broadcast channels and/or broadcast channel information, PC files, radio channels and/or radio channel information, menus and/or name search in mobile phones, etc., but is not limited thereto.

The interface generator 60 generates the interface picture and displays it on the display part 30.

The user selection part 70 is provided to input or select a predetermined function by a user. The user selection part 70 may be provided in various ways such as a plurality of input keys or buttons, a remote control, a keyboard, a mouse, etc. For example, if a user consecutively presses up and down keys of the keyboard or the remote control or an additional consecutive search function key, the consecutive search function, which consecutively searches for next search information until a user stops it, may be selected. In another exemplary embodiment of the present invention, the consecutive search function is stopped if a user stops pressing the up and down keys of the keyboard or the remote control, presses an additional stop button, or presses the consecutive search function again.

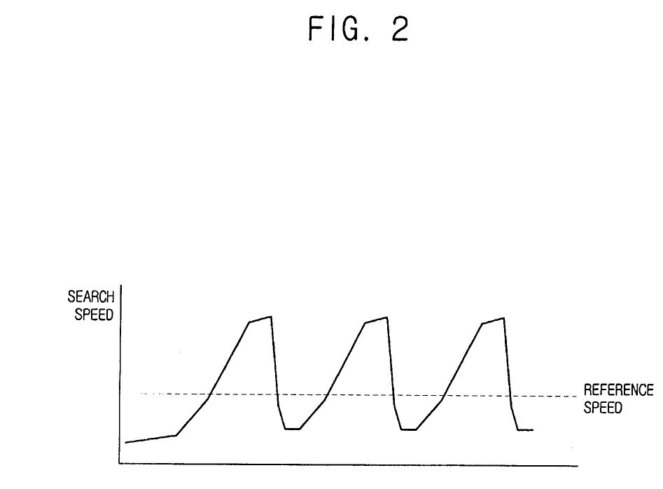

If the consecutive search function is selected through the user selection part 70, the controller 50 increases and decreases a search speed with respect to the search information. That is, the controller 50 increases and decreases the search speed compared to a predetermined reference speed if the consecutive search function is selected. As shown in FIG. 2, the search information is searched at a faster search speed than the predetermined reference speed, and then at a slower search speed than the reference speed after predetermined periods of time. In another exemplary embodiment, the search speed may periodically become faster and then slower again than the reference speed. In another exemplary embodiment of the present invention, the reference speed is a limit speed at which a user recognizes what is searched as the search information. As shown in FIG. 2, in an exemplary embodiment, the search speed and search increase/decrease rate are identical by each period. However the search speed need not necessarily be identical across periods. As long as the search speed becomes faster than the predetermined reference speed periodically, there is no limit to the range of the search speed and to the search increase/decrease rate.

According to an exemplary embodiment of the present invention, if the search information is displayed as a list on the display part 30, the searched search information may be distinguished from other search information. For example, if the memory 40 is stored with a plurality of files and the consecutive search function is operated to search for a user file, the controller 50 controls the display part 30 to display a file list stored in the memory 40 thereon and distinguishes the searched files from other file lists.

If the search information is not displayed as a list on the display part 30, single searched search information may be displayed thereon. A TV will be described as an example of the electronic apparatus according to an exemplary embodiment of the present invention.

If the TV is provided as the electronic apparatus according to an exemplary embodiment of the present invention, the signal processor 20 provided in the TV comprises a tuner 25 to select the broadcast channels. The tuner 25 processes the picture signal received through the selected broadcast channel among broadcast signals received from an antenna (not shown), to be displayed on the display part 30.

If the consecutive search function of the broadcast channel is selected through the user selection part 70, the controller 50 controls the tuner 25 to display the picture corresponding to the searched broadcast channel on the display part 30. Specifically, if the memory 40 stores information about the broadcast channel which is consecutively displayed on the display part 30 according to the consecutive search function, the controller 50 controls the tuner 25 to search the broadcast channel according to the order stored in the memory 40, and displays the picture corresponding to the searched broadcast channel on the display part 30.

Meanwhile, the controller 50 may control the interface generator 60 to display the interface picture comprising the menu for adjusting the consecutive search function, on the display part 30.

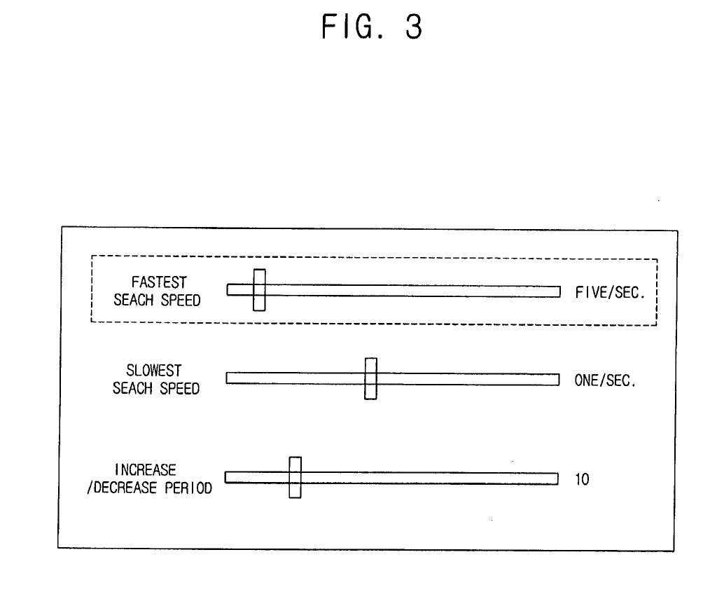

As shown in FIG. 3, the menu for adjusting the consecutive search function may comprise at least one of a speed adjusting menu comprising a fastest search speed, a slowest search speed, search speed increase/decrease rate (not shown), etc. and/or a period adjusting menu to adjust increase/decrease periods.

Referring to FIG. 3, if the interface picture is displayed on the display part 30 to adjust the fastest search speed, the fastest search speed may be adjusted through the user selection part 70. If the interface picture is displayed on the display part 30 to adjust the slowest search speed, the slowest search speed may be adjusted through the user selection part 70. In the present exemplary embodiment, the fastest search speed is faster than the preset reference speed and the slowest search speed is slower than the preset reference speed. However, these relative speed relationships are not necessary, and alternate embodiments exist.

If the interface picture is displayed on the display part 30 to adjust the increase/decrease period of the search speed, the increase/decrease period may be adjusted through the user selection part 70.

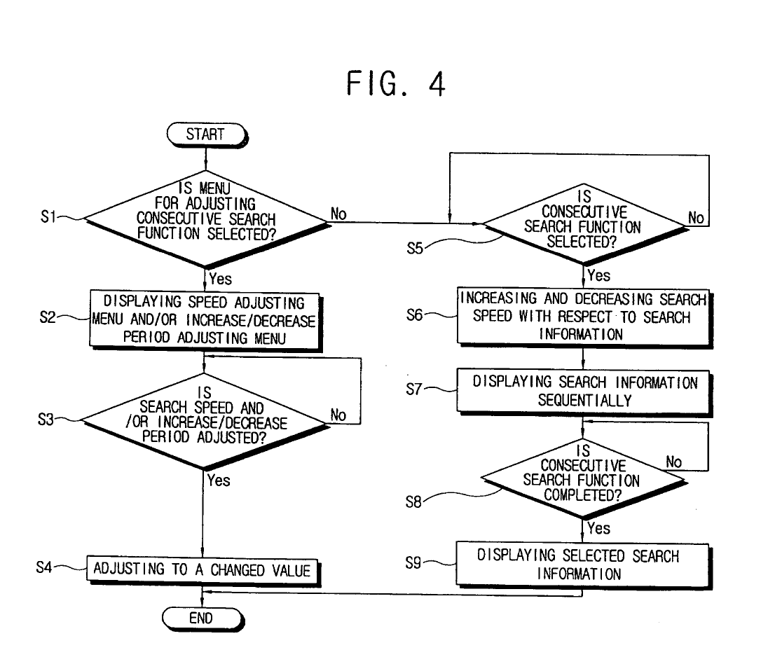

As shown in FIG. 4, the electronic apparatus according to the present invention may adjust the search speed and period through the menu for adjusting the consecutive search function. If the menu for adjusting the consecutive search function is selected through the user selection part 70 at operation S1, the controller 50 controls the interface generator 60 to display the interface picture comprising the speed adjusting menu having at least one of the fastest search speed, the slowest search speed, the search speed increase/decrease rate and the increase/decrease period of the search speed, and/or the menu for adjusting the increase/decrease period at operation S2. If a user adjusts the search speed and/or the increase/decrease period through the menu displayed on the interface picture at operation S3, the controller 50 searches the search information with the adjusted value at operation S4 if the consecutive search function is selected.

If the consecutive search function is selected through the user selection part 70 at operation S5, the search for the search information is started. At this time, the search speed is increased and decreased on the basis of the preset reference speed at operation S6. The search information which is searched according to the search speed is sequentially displayed on the display part 30 at operation S7.

In an exemplary embodiment of the present invention, the TV is provided as the electronic apparatus and the increase/decrease period is 10/sec. Also, in another embodiment of the present invention, the broadcast channel No. 2 is displayed on the display part 30 when the consecutive search function is selected. If the consecutive search function is selected through the user selection part 70, the broadcast channel is sequentially converted and displayed, and converted at a slower speed than the preset reference speed in broadcast channels such as No. 12, 22 etc. Thus, a user recognizes which channel is displayed on the display part 30 without difficulty, thereby stopping searching the broadcast channel at a broadcast channel that is close to the desired channel at operation S8. If the search is stopped, the display part 30 displays the search information searched when stopping the search at operation S9.

If the display part 30 displays a plurality of lists of the search information, the searched search information may be distinguished from other search information. Meanwhile, if displaying the searched search information only, the display part 30 may sequentially display the search information searched according to the search speed.

As described above, the electronic apparatus according to the present invention may reduce time to search the search information thanks to the high search speed. Further, a user may recognize the progress of the search without difficulty and stop searching at a point where the desired search information is close, as the search speed is low by each predetermined period. Thus, a user may receive the desired search information quickly and easily.

While a few exemplary embodiments of the present invention have been shown and described, it will be appreciated by those skilled in the art that changes may be made in these exemplary embodiments without departing from the principles and spirit of the invention, the scope of which is defined in the appended claims.

What is claimed is:

1. An electronic apparatus having a plurality of search information, comprising:
a display part;
a user selection part which selects a consecutive search function; and
a controller which controls a display part to increase and decrease a search speed of the search information, and allows a searched search information to be displayed on the display part when the consecutive search function is selected through the user selection part.

2. The electronic apparatus according to claim 1, wherein the display part displays a list of the search information, and displays the selected search information to be distinguished from other search information.

3. The electronic apparatus according to claim 2, further comprising:
an interface generator which generates an interface picture which is displayed on the display part, and
wherein the interface picture comprises a speed adjusting menu to adjust at least one of a fastest search speed, a slowest search speed and a search speed increase/decrease rate.

4. The electronic apparatus according to claim 2, wherein the search speed is increased and decreased periodically.

5. The electronic apparatus according to claim 4, further comprising:
an interface generator which generates an interface picture which is displayed on the display part, and
wherein the interface picture comprises a period adjusting menu to adjust increase/decrease periods of the search speed.

6. The electronic apparatus according to claim 1, wherein the display part displays the searched search information only.

7. The electronic apparatus according to claim 6, further comprising:
a tuner to select a broadcast channel,
wherein the searched search information comprises an image corresponding to a broadcast channel,
and wherein the controller controls the tuner to display an image corresponding to the searched broadcast channel on the display part if the consecutive search function is selected.

8. The electronic apparatus according to claim 6, further comprising:
an interface generator which generates an interface picture which is displayed on the display part, and
wherein the interface picture comprises a speed adjusting menu to adjust at least one of a fastest search speed, a slowest search speed and a search speed increase/decrease rate.

9. The electronic apparatus according to, claim 6, wherein the search speed is increased and decreased periodically.

10. The electronic apparatus according to claim 9, further comprising:
an interface generator which generates an interface picture which is displayed on the display part, and
wherein the interface picture comprises a period adjusting menu to adjust increase/decrease periods of the search speed.

11. The electronic apparatus according to claim 1, wherein the search speed is increased and decreased on the basis of a preset reference speed which is a recognition limit.

12. A control method of an electronic apparatus having a plurality of search information, comprising:
receiving a selection signal of a consecutive search function;
increasing and decreasing a search speed with respect to the search information if the selection signal of the consecutive search function is received; and
displaying a selected search information.

13. The control method according to claim 12, wherein the displaying the selected search information comprises displaying a list of the search information, and displaying a searched search information to be distinguished from other search information.

14. The control method according to claim 13, further comprising displaying a speed adjusting menu to adjust at least one of a fastest search speed, a slowest search speed and a search speed increase/decrease rate of the search speed.

15. The control method according to claim 13, wherein the search speed is increased and decreased periodically.

16. The control method according to claim 15, further comprising:
displaying a period adjusting menu to adjust a search period of the search speed.

17. The control method according to claim 12, wherein the displaying a searched search information comprises displaying the searched search information only.

18. The control method according to claim 17, wherein the searched search information comprises an image corresponding to a TV channel.

19. The control method according to claim 17, further comprising displaying a speed adjusting menu to adjust at least one of a fastest search speed, a slowest search speed and a search speed increase/decrease rate of the search speed.

20. The control method according to claim 17, wherein the search speed is increased and decreased periodically.

21. The control method according to claim 20, further comprising:
displaying a period adjusting menu to adjust a search period of the search speed.
